(19) United States
(12) Patent Application Publication
(10) Pub. No.: US 2010/0290020 A1
(43) Pub. Date: Nov. 18, 2010

(54) OPTICAL APPARATUS, EXPOSURE APPARATUS, EXPOSURE METHOD, AND METHOD FOR PRODUCING DEVICE

(76) Inventor: Shinichi MORI, Utsunomiya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/770,445

(22) Filed: Apr. 29, 2010

Related U.S. Application Data
(60) Provisional application No. 61/213,195, filed on May 15, 2009.

(51) Int. Cl. G03B 27/54; G02F 1/11

(52) U.S. Cl. 355/67; 359/285

(57) ABSTRACT

An optical apparatus, having a lens which is irradiated with an exposure light, includes a light source which emits a non-exposing light having a wavelength region different from that of the exposure light, an irradiation unit which irradiates a part of a surface of the lens with the non-exposing light emitted by the light source, an acousto-optic modulation element which is arranged between the light source and the surface of the lens, and an AOM driving system which drives the acousto-optic modulation element to change the irradiation position of the non-exposing light with respect to the surface of the lens. The optical apparatus can change the irradiation position of the light flux with respect to the optical element, with a simple construction or without generating any vibration.

### CROSS-REFERENCES TO RELATED APPLICATIONS

This application claims the benefit of priority of U.S. Provisional Application No. 61/213,195 filed on May 15, 2009, the entire disclosures of which are incorporated herein by reference.

### BACKGROUND OF THE INVENTION

Field of the Invention:

The present invention relates to an optical apparatus having an optical element which is irradiated with an illumination light (illumination light beam), an exposure apparatus which is provided with the optical apparatus, an exposure method, and a method for producing a device using the exposure apparatus or the exposure method.

### BACKGROUND ART

Description of the Related Art:

An exposure apparatus, which is used to transfer a pattern of a reticle to each of shot areas on a wafer (or a glass plate or the like) coated with a photoresist, when a semiconductor element, etc. is produced, is provided with an imaging characteristic correcting mechanism which corrects the imaging characteristic by controlling, for example, the position of a part of optical elements (a lens, etc.) constructing a projection optical system in order that the imaging characteristic is always maintained to be in a desired state.

Further, an exposure apparatus has been also suggested (see, for example, International Publication No. 2005/022614 and Japanese Patent Application Laid-open No. 2001-196305) in order to correct non-rotationally symmetric imaging characteristic such as the astigmatism (center astigmatism) on the optical axis generated, for example, when the dipole illumination (two-spot illumination) is executed, or higher-order imaging characteristic such as the higher-order spherical aberration feared to be generated, for example, when the illumination is executed with a small coherence factor (σ value), wherein a non-exposing light (non-exposing light beam), with which a photoresist is not exposed, is irradiated, onto a corresponding portion of an optical element, from an irradiation system which is arbitrarily selected from a plurality of irradiation systems arranged around a predetermined optical element (a lens, etc.) of a projection optical system.

### SUMMARY OF THE INVENTION

Recently, the electronic device (microdevice) as the production objective is diversified. In the exposure apparatus, for example, a pattern, which requires the use of such an illumination condition that the light amount distribution of exposure light (exposure light beam) provided during the conventional dipole illumination is rotated by a predetermined angle about the optical axis, is used as the exposure objective in some cases. In such a situation, in order to effectively correct the non-rotationally symmetric imaging characteristic, it is preferable that the irradiation position of the non-exposing light with respect to the optical element included in the projection optical system is changed in conformity with the light amount distribution of the exposure light. However, the irradiation position of the conventional irradiation system for the non-exposing light is fixed. Therefore, in order to respond to the change of the irradiation position as described above, it is necessary to previously arrange the irradiation systems at a large number of positions around the optical element depending on the illumination conditions to be possibly used. However, if the large number of irradiation systems are arranged as described above, then the construction or structure of the barrel portion of the projection optical system is complicated, and the production cost becomes expensive as well.

The following construction is also known. That is, the irradiation position of the non-exposing light may be changed within a wide range to some extent by using one irradiation system such that a guide groove is provided on a circumference about the center of the optical axis of a lens in the vicinity of a circumferential edge portion of the lens, and the end portion of an optical fiber for radiating the non-exposing light is constructed to be movable along with the guide groove. However, if the end portion of the optical fiber is moved, it is feared that any slight vibration might be generated in accordance with the movement of the end portion of the optical fiber, and the imaging characteristic of the projection optical system might be deteriorated by the vibration.

Taking the foregoing circumstances into consideration, an object of the present invention is to provide an optical apparatus having an optical element which is irradiated, for example, with a light flux for correcting the imaging characteristic, which is constructed simply, and which makes it possible to change the irradiation position of the light flux with respect to the optical element, or to provide an optical apparatus which is capable of changing the irradiation position of the light flux with respect to the optical element without generating any vibration. Further, another object of the present invention is to provide an exposure apparatus which is provided with the optical apparatus; an exposure method; and a method for producing a device by using the exposure apparatus or the exposure method.

According to a first aspect of the present invention, there is provided an optical apparatus having an optical element which is irradiated with a first illumination light, the optical apparatus comprising a light source which emits a second illumination light having a wavelength region different from that of the first illumination light; an irradiation mechanism which irradiates at least a part of a surface of the optical element with the second illumination light emitted by the light source; an acousto-optic system which is arranged between the light source and the surface of the optical element; and a controller which drives the acousto-optic system to change an irradiation position of the second illumination light with respect to the surface of the optical element.

According to a second aspect, there is provided an exposure apparatus which illuminates a pattern with an illumination light and which exposes an object with the illumination light via the pattern and a projection optical system; wherein the projection optical system includes the optical apparatus according to the first aspect as defined above.

According to a third aspect, there is provided an exposure method for illuminating a pattern with a first illumination light and exposing an object with the first illumination light via the pattern and a projection optical system, the exposure method comprising irradiating, with a second illumination light having a wavelength different from that of the first illumination light, an optical element included in the projection optical system, via an acousto-optic element; driving the acousto-optic element to change an irradiation area of the second illumination light to be irradiated onto the optical element; and illuminating the pattern with the first illumination light to expose the object with the first illumination light via the pattern and the projection optical system.

According to a fourth aspect, there is provided a method for producing a device, comprising forming a pattern of a photosensitive layer on a substrate by using the exposure apparatus or the exposure method as defined above; and processing the substrate formed with the pattern of the photosensitive layer.

### BRIEF DESCRIPTION OF THE DRAWINGS

FIG. 1 shows, with partial cutaway, a schematic construction of an exemplary exposure apparatus according to an embodiment.

FIG. 2A shows, with partial cutaway, a perspective view of a part of a construction of a non-exposing light irradiation apparatus 40 shown in FIG. 1; FIG. 2B shows a construction of irradiation units 48A to 48D shown in FIG. 2A; and FIG. 2C shows a construction of a time-sharing unit 44 shown in FIG. 2A.

FIG. 3A shows an L & S pattern in the X direction, and FIG. 3B shows a light amount distribution on a pupil plane of a projection optical system when the dipole illumination in the X direction is performed.

FIG. 4A shows an L & S pattern in the Y direction, and FIG. 4B shows a light amount distribution on the pupil plane of the projection optical system when the dipole illumination in the Y direction is performed.

FIG. 5A shows a sectional view illustrating irradiation positions of a non-exposing light when the dipole illumination in the Y direction is performed, and FIG. 5B shows a sectional view illustrating irradiation positions of the non-exposing light when the dipole illumination in the Y direction subjected to the rotation is performed.

FIG. 6 shows a magnified plan view illustrating exemplary L & S patterns in the X direction and the Y direction on a reticle.

FIG. 7A shows exemplary irradiation positions of the non-exposing light when the quadruple illumination is performed, and FIG. 7B shows exemplary irradiation positions of the non-exposing light when the small σ illumination is performed.

FIG. 8 shows a perspective view of an exemplary irradiation unit in which the irradiation position can be changed two-dimensionally.

FIG. 9 shows a flow chart illustrating exemplary steps of producing an electronic device.

### DESCRIPTION OF THE PREFERRED EMBODIMENTS

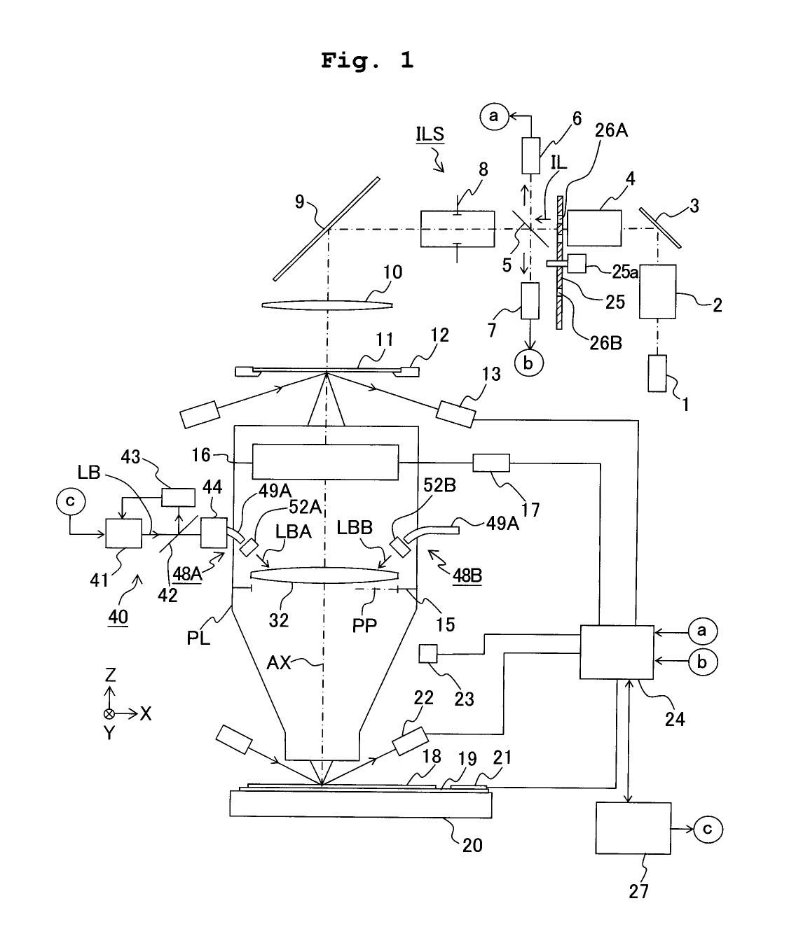

An exemplary embodiment of the present invention will be explained below with reference to FIGS. 1 to 7.

FIG. 1 shows a schematic construction of an exposure apparatus (projection exposure apparatus) of the scanning exposure type constructed of a scanning stepper of this embodiment. With reference to FIG. 1, the exposure apparatus includes an exposure light source 1, an illumination optical system ILS which illuminates a pattern surface of a reticle 11 (mask) with an exposure light (illumination light for the exposure) IL emitted from the exposure light source 1, and a reticle stage 12 which is movable while holding the reticle 11. The exposure apparatus further includes a projection optical system PL which projects an image of a pattern of the reticle 11 onto a wafer 18 (object), a wafer stage 20 which is movable while holding the wafer 18, and a main control system 24 which is constructed of a computer integrally controlling the operation of the entire apparatus.

The following description will be made assuming that the Z axis extends in parallel to an optical axis AX of the projection optical system PL, the Y axis extends in a scanning direction (direction perpendicular to the sheet surface of FIG. 1) for the reticle 11 and the wafer 18 upon performing the scanning exposure in a plane (substantially a horizontal plane in this embodiment) perpendicular to the Z axis, and the X axis extends in a non-scanning direction (direction parallel to the sheet surface of FIG. 1) perpendicular to the scanning direction. The directions of rotation (directions of inclination) about the axes parallel to the X axis, the Y axis, and the Z axis are referred to as “θx direction”, “θy direction”, and “θz direction” as well.

At first, an ArF excimer laser light source (wavelength: 193 nm) is used as the exposure light source 1. Those usable as the exposure light source also include, for example, an ultraviolet laser light source such as a KrF excimer laser light source (wavelength: 248 nm), a high harmonic wave generator such as a YAG laser or a solid laser (a semiconductor laser, etc.), and a mercury lamp (i-ray, etc.).

An exposure light IL, which is pulse-emitted from the exposure light source 1 upon the exposure, is allowed to travel, for example, via an unillustrated beam-shaping optical system, etc.; and the exposure light IL comes into a first fly's eye lens 2 which serves as an optical integrator, and the illuminance distribution is uniformized. The exposure light IL, which exits from the first fly's eye lens 2, is allowed to travel along an unillustrated relay lens and a vibration mirror 3 for reducing, for example, the speckle; and the exposure light IL comes into a second fly's eye lens 4 which serves as an optical integrator, and the illuminance distribution is further uniformized. It is also possible to use, for example, a diffractive optical element (DOE) or an internal reflection type integrator (a rod lens, etc.), instead of the fly's eye lenses 2, 4.

An illumination system aperture diaphragm member 25, which is provided to determine the illumination condition by setting the light amount distribution of the exposure light IL (secondary light source) to any one of a small circle (small σ illumination), an ordinary circle, a plurality of eccentric areas (dipole illumination and quadruple illumination), an annular area, etc. is arranged on the focal plane disposed on the light-exit side of the second fly's eye lens 4 (pupil plane of the illumination optical system ILS) so that the illumination system aperture diaphragm member 25 is rotatable by a driving motor 25a. The main control system 24 sets the illumination condition by controlling the angle of rotation of the illumination system aperture diaphragm member 25 via the driving motor 25a. Those appear in a state shown in FIG. 1 are an aperture diaphragm 26A which is provided for a first dipole illumination (two-spot illumination) having two circular apertures formed symmetrically about the center of the optical axis and an aperture diaphragm 26B which is provided for a second dipole illumination having a shape as obtained by rotating the aperture diaphragm 26A by 90°, among a plurality of aperture diaphragms (σ diaphragms) of the illumination system aperture diaphragm member 25.

Another aperture diaphragm (not shown), which is provided by rotating each of the aperture diaphragms 26A, 26B by a slight angle (for example, several degrees) as described later on, is used in some cases depending on the structure of the electronic device as the production objective. The another aperture diaphragm as described above is constructed so that the another aperture diaphragm can be attached to and detached from the illumination system aperture diaphragm member 25, if necessary.

The exposure light IL, which is allowed to pass through the aperture diaphragm (aperture diaphragm 26A in FIG. 1) of the illumination system aperture diaphragm member 25, comes into a beam splitter 5 having a small reflectance. The exposure light, which is reflected by the beam splitter 5, is received by an integrator sensor 6 via a light-collecting lens (not shown). The detection signal of the integrator sensor 6 is supplied to an exposure amount control section and an imaging characteristic calculating section included in the main control system 24. The exposure amount control section indirectly calculates the exposure energy on the wafer 18 by using the detection signal and a previously measured transmittance of the optical system ranging from the beam splitter 5 to the wafer 18. The exposure amount control section controls the output of the exposure light source 1 so that the totalized exposure energy on the wafer 18 is included in a target range, and the exposure amount control section controls, in a stepwise manner, the pulse energy of the exposure light IL by using an unillustrated dimming or light-reducing mechanism, if necessary.

The exposure light IL, which is transmitted through the beam splitter 5, comes into an aperture of a field diaphragm 8 via an unillustrated relay lens. The field diaphragm 8 is actually constructed by a fixed field diaphragm (fixed blind) and a movable field diaphragm (movable blind). The exposure light IL, which is allowed to pass through the aperture of the field diaphragm 8, is allowed to travel along an unillustrated condenser lens, an optical path-folding mirror 9, and a condenser lens 10; and the exposure light IL illuminates a rectangular illumination area of the pattern surface (lower surface) of the reticle 11 which is long in the X direction at a uniform illuminance distribution.

The pattern in the illumination area of the reticle 11, which is illuminated with the exposure light IL, is projected onto an exposure area (area conjugate with the illumination area) on one shot area on the wafer 18 at a projection magnification β (β is 1/4, 1/5, etc.) via the projection optical system PL which is telecentric on the both sides. The wafer 18 is prepared by coating, with a photoresist (photosensitive agent), a disk-shaped base material which is composed of, for example, silicon or SOT (silicon on insulator) and which has a diameter of about 200 mm to 450 mm.

A part of the exposure light IL is reflected by the wafer 18. The reflected light (reflected light beam) of the exposure light IL is allowed to return to the beam splitter 5, via the projection optical system PL, the reticle 11, the condenser lens 10, etc. The light (light beam), which is further reflected by the beam splitter 5, is allowed to travel via a light-collecting lens (not shown), and the light is received by a reflection amount sensor 7 which serves as a first photoelectric sensor. The detection signal of the reflection amount sensor 7 is supplied to the imaging characteristic calculating section included in the main control system 24. The imaging characteristic calculating section calculates the totalized energy of the exposure light IL allowed to come into the projection optical system PL from the reticle 11 and the totalized energy of the exposure light IL reflected by the wafer 18 and returned to the projection optical system PL by using the detection signals of the integrator sensor 6 and the reflection amount sensor 7. The information about the illumination condition during the exposure (type of the illumination system aperture diaphragm) is also supplied to the imaging characteristic calculating section. Further, an environmental sensor 23, which is provided to measure the atmospheric pressure and the temperature, is arranged outside the projection optical system PL. The measurement data of the environmental sensor 23 is also supplied to the imaging characteristic calculating section. The imaging characteristic calculating section included in the main control system 24 calculates the fluctuation amounts of the rotationally symmetric aberration component and the non-rotationally symmetric aberration component of the imaging characteristic of the projection optical system PL by using the information about the illumination condition, the totalized energy of the exposure light IL, the surrounding atmospheric pressure, the temperature, etc. An imaging characteristic control section is also provided in the main control system 24. The imaging characteristic control section suppresses the fluctuation amount of the imaging characteristic depending on the calculation result of the fluctuation amount of the aberration component so that a desired imaging characteristic is always obtained (details will be described later on).

The illumination optical system ILS is constructed by including the fly's eye lenses 2, 4, the mirrors 3, 9, the illumination system aperture diaphragm member 25, the field diaphragm 8, the condenser lens 10, etc.

The projection optical system PL is a dioptric system. The plurality of optical elements, which constitute the projection optical system PL, include a plurality of lenses which are composed of silica glass and which are rotationally symmetric about the center of the optical axis AX; a flat plate-shaped aberration-correcting plate which is composed of silica glass; etc. The lenses, the aberration-correcting plate, etc. may be formed of, for example, calcium fluoride (CaF₂). An aperture diaphragm 15 is arranged on a pupil plane PP of the projection optical system PL (plane conjugate with the pupil plane of the illumination optical system ILS), and a lens 32 is arranged in the vicinity of the pupil plane PP. The lens 32 is irradiated (radiated) with an illumination light which has a wavelength region different from that of the exposure light IL in order to correct the non-rotationally symmetric aberration (details will be described later on), etc. An imaging characteristic correcting mechanism 16, which is provided to correct the rotationally symmetric aberration (for example, the distortion, the magnification error, the coma aberration, or the wave aberration), is incorporated into the projection optical system PL. The imaging characteristic control section included in the main control system 24 controls the operation of the imaging characteristic correcting mechanism 16 via a controller 17.

The imaging characteristic correcting mechanism 16 controls the position in the optical axis direction (Z direction) and the angles of inclination in the θx direction and the θy direction of a plurality of (for example, five) lenses selected from the plurality of optical elements in the barrel of the projection optical system PL as disclosed, for example, in United States Patent Application Publication No. 2006/244940.

Next, the reticle 11 is attracted and held on the reticle stage 12. The reticle stage 12 is movable at a constant velocity in the Y direction on an unillustrated reticle base, and the reticle stage 12 is finely movable in the X direction, the Y direction, and the θz direction so that the synchronization error is corrected to perform the scanning for the reticle 11. At least the positions in the X direction and the Y direction and the angle of rotation in the θz direction of the reticle stage 12 are measured by a laser interferometer (not shown); and the measured value thereof is supplied to a stage control section included in the main control system 24. The stage control section controls the position and the velocity of the reticle stage 12 based on the measured value and various control informations. An auto-focus sensor of the oblique incidence system (hereinafter referred to as “reticle side AF sensor”) 13, which projects a detecting light (detecting light beam) obliquely onto the pattern surface (reticle surface) of the reticle 11 to detect the displacement of the reticle surface in the Z direction, is arranged on the upper side surface of the projection optical system PL. The detection information, which is obtained by the reticle side AF sensor 13, is supplied to a Z tilt stage control section included in the main control system 24. A reticle alignment system (not shown) is arranged over or above the circumferential portion of the reticle 11.

On the other hand, the wafer 18 is attracted and held on a Z tilt stage 19 via a wafer holder (not shown). The Z tilt stage 19 is fixed on a wafer stage 20. The wafer stage 20 is movable at a constant velocity in the Y direction on an unillustrated wafer base, and the wafer stage 20 is step-movable in the X direction and the Y direction. The Z tilt stage 19 controls the position of the wafer 18 in the Z direction and the angles of inclination in the θx direction and the θy direction. At least the positions in the X direction and the Y direction and the angle of rotation in the θz direction of the wafer stage 20 are measured by a laser interferometer (not shown); and the measured value is supplied to the stage control section included in the main control system 24. The stage control section controls the position and the velocity of the wafer stage 20 based on the measured value and various control informations. An auto-focus sensor of the oblique incidence system (hereinafter referred to as “wafer side AF sensor”) 22, which projects a detecting light obliquely onto a surface (wafer surface) of the wafer 18 to detect the displacement of the wafer surface in the Z direction and the angles of inclination in the θx direction and the θy direction, is arranged on the lower side surface of the projection optical system PL. The detection information, which is obtained by the wafer side AF sensor 22, is supplied to the Z tilt stage control section included in the main control system 24. The Z tilt stage control section drives the Z tilt stage 19 in the auto-focus manner based on the detection informations of the reticle side AF sensor 13 and the wafer side AF sensor 22 so that the wafer surface is always focused on the image plane of the projection optical system PL.

An irradiation amount sensor 21, which is constructed of a photoelectric sensor detecting the exposure light IL, is fixed at a position near to the wafer 18 on the Z tilt stage 19. The detection signal of the irradiation amount sensor 21 is supplied to the exposure amount control section included in the main control system 24. A light-receiving surface of the irradiation amount sensor 21 is moved to the exposure area of the projection optical system PL periodically or before the start of the exposure, and the detection signal of the irradiation amount sensor 21 is divided by the detection signal of the integrator sensor 6. By doing so, it is possible to calculate the transmittance of the optical system ranging from the beam splitter 5 to the irradiation amount sensor 21 (wafer 18).

A wafer alignment system (not shown) of the off-axis system is arranged over or above the wafer stage 20. The main control system 24 performs the alignment for the reticle 11 and the alignment for the wafer 18 based on the detection results of the reticle alignment system and the wafer alignment system.

When the exposure is performed, an operation in which the reticle stage 12 and the wafer stage 20 are driven to synchronously scan the reticle 11 and one shot area on the wafer 18 in the Y direction while irradiating the illumination area on the reticle 11 with the exposure light IL and an operation in which the wafer stage 20 is driven to step-move the wafer 18 in the X direction and the Y direction are repeated. In accordance with the operations, each of the shot areas on the wafer 18 is exposed with the pattern image of the reticle 11 in the step-and-scan manner.

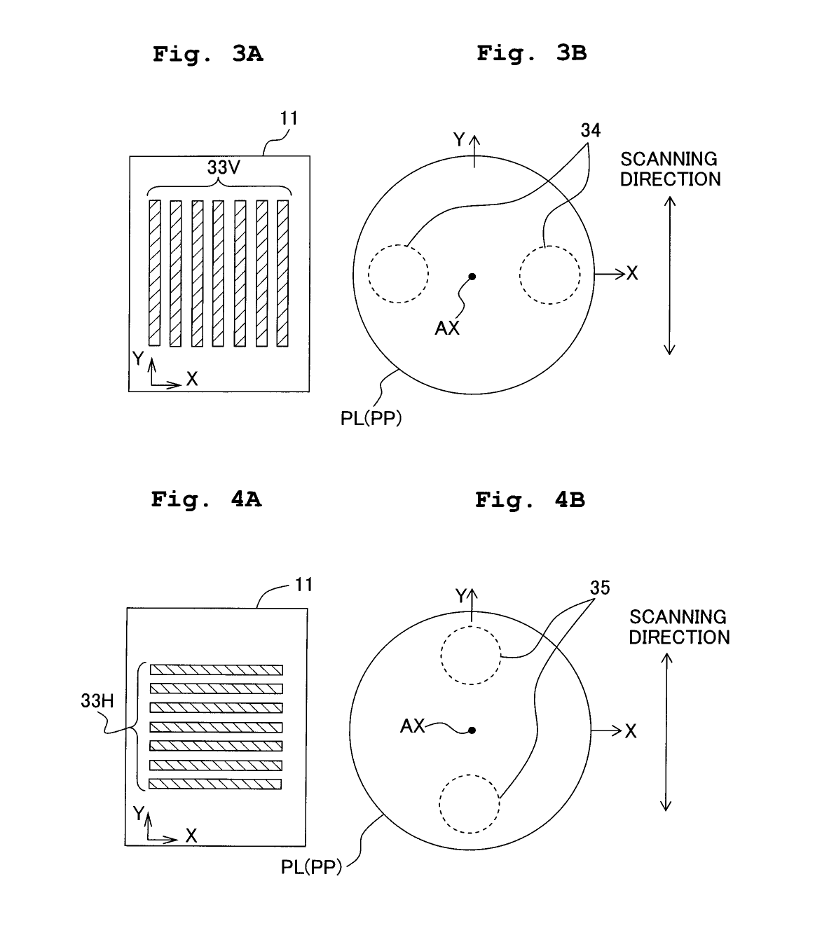

In this embodiment, the aperture diaphragm 26A for the dipole illumination in the X direction, which has two apertures separated from each other in a direction corresponding to the X direction, is arranged on the pupil plane of the illumination optical system ILS shown in FIG. 1. In this case, as shown in FIG. 3A while being magnified by way of example, a principal transfer pattern, which is formed on the reticle 11, is a line-and-space pattern (hereinafter referred to as “L & S pattern”) 33V in the X direction in which line patterns long in the Y direction are arranged in the X direction (non-scanning direction) at a pitch (period) approximately close to the resolution limit of the projection optical system PL. In this case, for example, a plurality of other L & S patterns, which have an arrangement pitch larger than that of the L & S pattern 33V and which have the arrangement directions of the X direction and the Y direction (scanning direction), are usually formed on the reticle 11 as well.

In the dipole illumination in the X direction using the aperture diaphragm 26A, if it is assumed that the reticle is absent, then as shown in FIG. 3B, two circular areas 34, which are symmetric in the X direction with the optical axis AX intervening therebetween, are illuminated with the exposure light IL on the pupil plane PP of the projection optical system PL. Even in a case that various reticle patterns are arranged in the optical path of the exposure light IL, a greater part of the exposure light IL (imaging light flux) is allowed to pass through the areas 34 or the vicinity thereof, because the light amount of the zero-order light (zero-order light beam) is usually larger than the light amount of the diffracted light to a considerable extent, and because the angle of diffraction is small as well. When the reticle 11 shown in FIG. 3A is arranged in the optical path of the exposure light IL, the image of the L & S pattern 33V can be projected onto the wafer at a high resolution, because the ±1st-order diffracted lights from the L & S pattern 33V having the pitch close to the resolution limit are also allowed to pass approximately through the areas 34 or the vicinity thereof.

In this state, the exposure light IL, which comes into the lens 32 disposed in the vicinity of the pupil plane PP of the projection optical system PL shown in FIG. 1, has the light amount distribution which is approximately the light amount distribution shown in FIG. 3B as well. Therefore, when the exposure is continued, then the temperature distribution of the lens 32 disposed in the vicinity of the pupil plane PP becomes non-rotationally symmetric, and the non-rotationally symmetric aberration including, for example, the astigmatism (center astigmatism) on the optical axis is caused.

On the other hand, as shown in FIG. 4A while being magnified, the following situation is assumed. That is, a L & S pattern 33H in the Y direction, in which line patterns long in the X direction are principally arranged in the Y direction (scanning direction) at a pitch approximately close to the resolution limit of the projection optical system PL, is formed on the reticle 11. In this case, the aperture diaphragm 26B, which has the shape obtained by rotating the aperture diaphragm 26A by 90°, is set on the pupil plane of the illumination optical system ILS shown in FIG. 1. In the dipole illumination in the Y direction using the aperture diaphragm 26B, if it is assumed that the reticle is absent, then as shown in FIG. 4B, two circular areas 35, which are symmetric in the Y direction with the optical axis AX intervening therebetween, are illuminated with the exposure light IL on the pupil plane PP of the projection optical system PL. In this situation, even when various reticle patterns are arranged in the optical path of the exposure light IL, a greater part of the exposure light IL (imaging light flux) is allowed to pass through the areas 35 or the vicinity thereof in ordinary cases. When the reticle 11 shown in FIG. 4A is arranged in the optical path of the exposure light IL, the image of the L & S pattern 33H is projected onto the wafer at a high resolution, because the ±1st-order diffracted lights, which come from the L & S pattern 33H having the pitch close to the resolution limit, are also allowed to pass approximately through the areas 35 or the vicinity thereof.

In this case, the exposure light IL, which comes into the lens 32 disposed in the vicinity of the pupil plane PP of the projection optical system PL shown in FIG. 1, has the light amount distribution which is approximately the light amount distribution shown in FIG. 4B as well. Therefore, when the exposure is continued, then the temperature distribution of the lens 32 becomes non-rotationally symmetric, and the non-rotationally symmetric aberration including, for example, center astigmatism, which has a sign different from that provided when the dipole illumination in the X direction is used, is caused.

Further, in a case that a pattern, which is obtained by rotating, for example, the L & S pattern 33H shown in FIG. 4A clockwise by several degrees, is principally formed on the reticle 11, the imaging light flux on the pupil plane PP of the projection optical system PL is allowed to pass principally through areas obtained by rotating the circular areas 35 shown in FIG. 4B clockwise by several degrees or areas disposed in the vicinity thereof. Therefore, the non-rotationally symmetric aberration is caused.

The non-rotationally symmetric aberration, which includes the center astigmatism, etc. as described above, cannot be substantially corrected by the imaging characteristic correcting mechanism 16 shown in FIG. 1. In a case that any other non-rotationally symmetric illumination condition is used, the non-rotationally symmetric aberration is caused as well. Further, in a case that the small a illumination is used as the illumination condition, the light amount distribution of the exposure light IL is greatly changed in the radial direction on the pupil plane of the illumination optical system ILS (pupil plane of the projection optical system PL). In this case, it is also feared that any higher-order rotationally symmetric aberration, which includes the higher-order spherical aberration, etc. and which cannot be satisfactorily corrected by the imaging characteristic correcting mechanism 16, might arise. In view of the above, in this embodiment, in order to correct the non-rotationally symmetric aberration or the higher-order rotationally symmetric aberration, a non-exposing light (non-exposing light beam) LB, which is an illumination light (illumination light beam) for correcting the aberration and which has the wavelength region different from that of the exposure light IL, is irradiated onto the lens 32 disposed in the vicinity of the pupil plane PP of the projection optical system PL with reference to FIG. 1. An explanation will be made in detail below about the construction of a non-exposing light irradiation mechanism 40 for irradiating the lens 32 with the non-exposing light LB and an operation for correcting the imaging characteristic.

In this embodiment, a light (light beam), which is in such a wavelength region that the photoresist coated on or applied to the wafer 18 is scarcely exposed, is used as the non-exposing light LB. As an example, an infrared laser beam having a wavelength of, for example, 10.6 μm, which is continuously emitted or pulse-emitted from a carbon dioxide gas laser (CO₂ laser), is used as the non-exposing light LB. The infrared light having the wavelength of 10.6 μm is highly absorptive with respect to silica glass. Almost all (desirably not less than 90%) of the infrared light having the wavelength of 10.6 μm is absorbed by one lens included in the projection optical system PL. Therefore, the infrared light having the wavelength of 10.6 μm is advantageous in that the infrared light is easily usable in order to control the aberration without exerting any influence on the other lenses. The setting is made such that not less than 90% of the non-exposing light LB (LBA, LBB, etc.) with which the lens 32 is irradiated is absorbed. Other than the above, those usable as the non-exposing light LB also include, for example, a near infrared laser beam having a wavelength of about 1 μm emitted from a solid laser such as a YAG laser or the like and an infrared laser beam having a wavelength of about several μm emitted from a semiconductor laser.

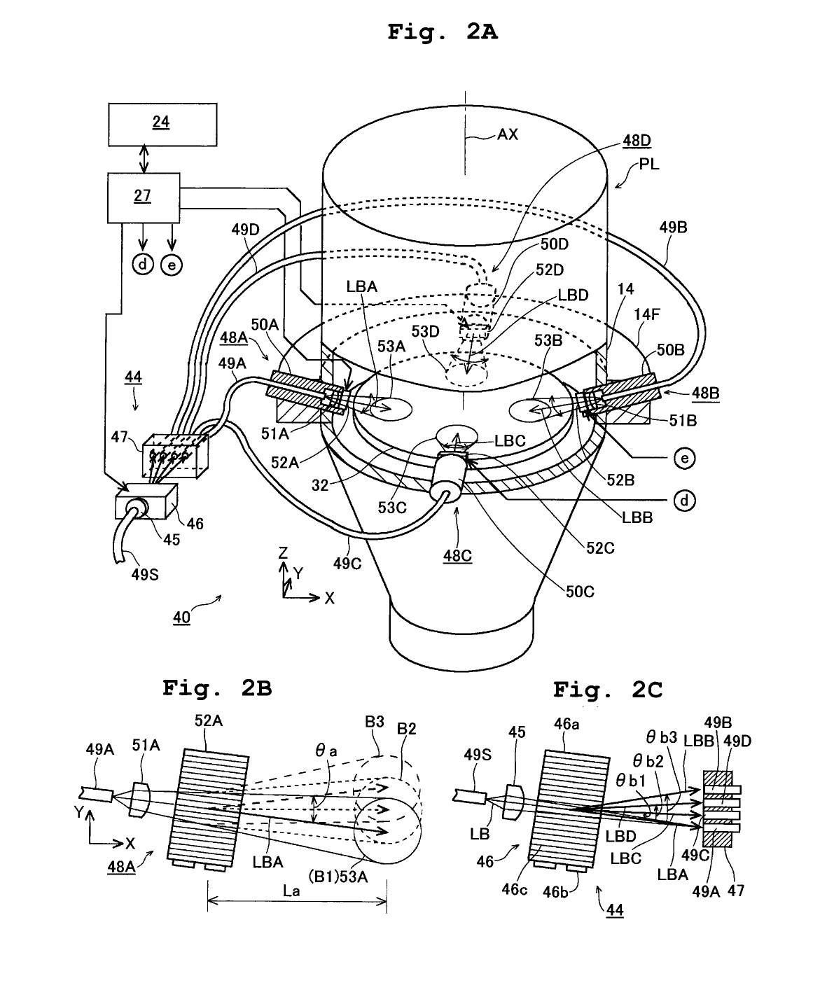

In the non-exposing light irradiation mechanism 40 shown in FIG. 1, the non-exposing light LB, which is composed of the laser beam emitted from a light source system 41, has a slight part which is branched by a beam splitter 42 and which is directed to a photoelectric sensor 43. The non-exposing light LB, which is transmitted through the beam splitter 42, is directed to a time-sharing unit 44. The detection signal, which corresponds to the light amount of the non-exposing light LB detected by the photoelectric sensor 43, is subjected to the feedback to the light source system 41. Two non-exposing lights LBA, LBB, which are included in four non-exposing lights LBA, LBB, LBC, LBD (see FIG. 2A) obtained by time-sharing the non-exposing light LB into four light fluxes by the time-sharing unit 44, are irradiated onto the lens 32 via two irradiation units 48A, 48B and acousto-optic modulation elements (hereinafter referred to as “AOM” or “AOM's”) 52A, 52B which are arranged to interpose the projection optical system PL in the X direction. The operations of, for example, AOM's 52A, 52B and the light-emitting operation and the output of the light source system 41 are controlled by an AOM driving system 27. The AOM driving system 27 is controlled by the main control system 24.

FIG. 2A shows a detailed construction of the non-exposing light irradiation mechanism 40. With reference to FIG. 2A, the plurality of optical elements, which include the lens 32 of the projection optical system PL, are retained or held in a barrel 14 via lens holders (not shown) respectively. The barrel 14 is supported by a frame (not shown) via a flange portion 14F. FIG. 2A shows the barrel 14, the flange portion 14F, and holding members 50A, 50B (to be described later on) with a partial cutoff.

The non-exposing light LB, which is a linearly polarized light transmitted through the beam splitter 42 shown in FIG. 1, comes into a light-incident end (not shown) of an optical fiber 49S of the time-sharing unit 44 shown in FIG. 2A via an unillustrated light-collecting lens. The non-exposing light LB, which is transmitted through the optical fiber 49S and which exits from a light-exit end of the optical fiber 49S, comes into AOM (acousto-optic modulation element) 46 via a light-collecting lens 45. The non-exposing lights LBA, LBB, LBC, LBD, which are deflected to have different angles in a time-sharing manner by AOM 46, are allowed to come into light-incident ends of optical fibers 49A, 49B, 49C, 49D fixed to a fixing member 47 respectively. Those usable as the optical fibers 49A to 49D, 49S include, for example, a multi-mode optical fiber which has a core diameter of about 50 μm and a clad diameter of about 125 μm and a single mode optical fiber which has a core diameter of about 10 μm and a clad diameter of about 125 μm.

As shown in FIG. 2C, in the time-sharing unit 44 shown in FIG. 2A, the non-exposing light LB, which exits from the optical fiber 49S, is collected on an end surface of the fixing member 47 (light-incident ends of the optical fibers 49A to 49D) via the AOM 46 by the light-collecting lens 45. The AOM 46 includes an acousto-optic medium 46a through which the non-exposing light LB composed of the laser beam is transmitted, and a transducer 46b which generates an ultrasonic wave 46c in the acousto-optic medium 46a to produce the 1st-order Bragg diffracted light (the 1st-order Bragg diffracted light beam) (Bragg reflected light, Bragg reflected light beam). The transducer 46b is driven by the AOM driving system 27. The AOM 46 is driven, for example, at a center frequency of about 40 MHz to 60 MHz in a modulation band of about 10 MHz. For example, germanium (Ge), in which the usable wavelength region is about 2 μm to 12 μm, is usable as the acousto-optic medium 46a. When the wavelength of the non-exposing light LB is about 0.6 μm to 10 μm, gallium-phosphorus (GaP) is also usable as the acousto-optic medium 46a. When the wavelength of the non-exposing light LB is about 0.4 μm to 5 μm, tellurium dioxide (TeO₂) is also usable as the acousto-optic medium 46a. In a case that the acousto-optic medium 46a is composed of germanium or gallium-phosphorus, a polarization-maintaining fiber may be used as the optical fiber 49S and the optical fibers 49A to 49D, because the incident light flux is preferably the linearly polarized light.

With reference to FIG. 2C, the AOM 46 is driven so that the diffraction angle of the 1st-order diffracted light with respect to the incident non-exposing light LB is any one of a predetermined small angle, θb1, θb2, and θb3 (four diffraction angles). The 1st-order diffracted lights, which have the diffraction angles of the small angle, θb1, θb2, and θb3, are allowed to come into the light-incident ends of the optical fibers 49A, 49C, 49D, 49B as the non-exposing lights LBA, LBC, LBD, LBB respectively. In accordance with the time-sharing driving, the non-exposing light LB, which is transmitted by the optical fiber 49S, can be successively supplied to any one of the optical fibers 49A to 49D as the non-exposing light LBA to LBD.

With reference to FIG. 2A, the light-exit ends of the optical fibers 49A, 49B, 49C, 49D are fixed in cylindrical support members 50A, 50B, 50C, 50D fixed to through-holes provided on the flange portion 14F and the barrel 14 of the projection optical system PL respectively. Among the support members 50A to 50D, one pair of the support members 50A, 50B are arranged so that the upper surface of the lens 32 is interposed therebetween in the X direction and the center axes of the support members 50A, 50B obliquely intersect the upper surface of the lens 32. Another pair of the support members 50C, 50D are arranged so that the upper surface of the lens 32 is interposed therebetween in the Y direction and the center axes of the support members 50C, 50D obliquely intersect the upper surface of the lens 32.

Light-collecting lenses 51A, 52B are arranged at the light-exit ends of the optical fibers 49A, 49B in the support members 50A, 50B respectively. AOM's 52A, 52B are arranged between the light-collecting lenses 51A, 51B and the lens 32. The pair of irradiation units 48A, 48B, which are arranged to interpose the lens 32 in the X direction therebetween respectively, are constructed by including the optical fibers 49A, 49B, the support members 50A, 50B, and the light-collecting lenses 51A, 51B. Similarly, the pair of irradiation units 48C, 48D, which are arranged to interpose the lens 32 in the Y direction therebetween respectively, are constructed by including the optical fibers 49C, 49D, the support members 50C, 50D, and the light-collecting lenses included therein (not shown). Further, AOM's 52C, 52D, which are fixed to the end portions of the support members 50C, 50D, are arranged between the irradiation units 48C, 48D and the lens 32. The AOM's 52A to 52D are constructed in the same manner as the AOM 46. The AOM's 52A to 52D are driven by the AOM driving system 27, for example, at a center frequency of about 40 MHz to 60 MHz in a modulation band of about 10 MHz.

In the irradiation unit 48A, as shown in FIG. 2B, the non-exposing light LBA, which exits from the optical fiber 49A, comes into the AOM 52A via the light-collecting lens 51A. The 1st-order Bragg diffracted light, which exits from the AOM 52A, is irradiated onto a substantially circular (or elliptic) irradiation area 53A on the surface of the lens 32. The AOM 52A is driven so that the diffraction angle of the 1st-order light has an arbitrary value within a range of θa (rad) (for example, a value corresponding to several degrees), as indicated by the light allowed to come into a central portion of the irradiation area 53A. In this case, assuming that La represents a distance from the center of the AOM 52A to the center of the irradiation area 53A, the irradiation area can be moved to any arbitrary position approximately within a range of La•θa in the Y direction on the lens 32. The position in the −Y direction in the variable range of the irradiation area 53A is designated as B1, the center position is designated as B2, and the position in the +Y direction is designated as B3. It is possible to widen the variable range of the irradiation area 53A between the positions B1 and B3 by lengthening the distance La. If necessary, it is also allowable to provide a light shielding member for intercepting or shielding the zero-order lights emitted from the AOM's 52A to 52D and a cooling mechanism for the light-shielding member.

With reference to FIG. 2A, the non-exposing lights LBB, LBC, LBD, which are emitted from the other irradiation units 48B, 48C, 48D, are irradiated onto the irradiation area 53B which is variable in the Y direction, the irradiation area 53C which is variable in the X direction, and the irradiation area 53D which is variable in the X direction on the lens 32 respectively. The irradiation areas 53A, 53B, each of which is disposed at the center of the variable range brought about by the pair of irradiation units 48A, 48B, are set symmetrically so that the optical axis AX is interposed therebetween in the X direction at the circumferential edge portions of the lens 32. The irradiation areas 53C, 53D, each of which is disposed at the center of the variable range brought about by the other pair of irradiation units 48C, 48D, are set symmetrically so that the optical axis AX is interposed therebetween in the Y direction at the circumferential edge portions of the lens 32.

Next, an explanation will be made about various operations for correcting or reducing the non-rotationally symmetric aberration by irradiating the lens 32 disposed in the vicinity of the pupil plane PP of the projection optical system PL with the non-exposing light from the non-exposing light irradiation apparatus 40, in a case that the non-rotationally symmetric illumination condition is used.

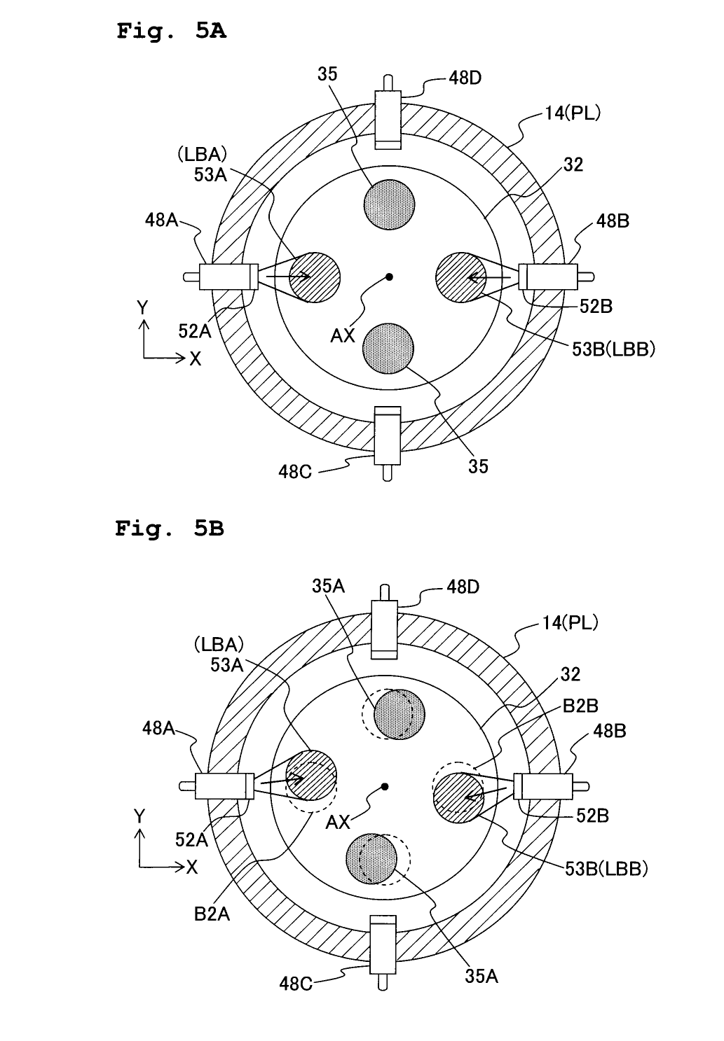

At first, in a case that the L & S pattern 33H shown in FIG. 4A is principally formed on the reticle 11, the dipole illumination in the Y direction shown in FIG. 4B is used. As shown in FIG. 5A, as for the lens 32 disposed in the vicinity of the pupil plane PP of the projection optical system PL, the two circular areas 35, which interpose the optical axis AX symmetrically in the Y direction, are irradiated with the exposure light IL. In this case, the information about the illumination condition and the irradiation amount of the exposure light IL is supplied from the main control system 24 to the AOM driving system 27; and the AOM driving system 27 emits the non-exposing light LB from the light source system 41 of the non-exposing light irradiation unit 40 depending on the irradiation amount of the exposure light IL. Further, the AOM driving system 27 drives the AOM 46 included in the time-sharing unit 44 shown in FIG. 2C, and the incident non-exposing light LB is alternately supplied as the non-exposing lights LBA, LBB to the optical fibers 49A, 49B at approximately identical time intervals. Further, the AOM driving system 27 drives the AOM's 52A, 52B shown in FIG. 5A, so that the non-exposing lights LBA, LBB, which are allowed to exit from the two irradiation units 48A, 48B, are irradiated onto the irradiation areas 53A, 53B disposed at the positions to interpose the optical axis AX symmetrically in the Y direction on the lens 32. Actually, the non-exposing lights LBA, LBB are alternately irradiated onto the irradiation areas 53A, 53B.

Accordingly, the lens 32 has the temperature distribution which is approximately rotationally symmetric (uniform in the circumferential direction). Therefore, the non-rotationally symmetric aberration, which includes the center astigmatism, etc. is corrected.

On the other hand, in a case that the L & S pattern, which is provided by rotating the L & S pattern 33H shown in FIG. 4A clockwise by several degrees, is principally formed on the reticle 11, the dipole illumination, which is provided by rotating the dipole illumination in the Y direction shown in FIG. 4B clockwise by the same angle, is used. As shown in FIG. 5B, as for the lens 32 of the projection optical system PL, the two circular areas 35A, which are disposed at the positions provided by rotating the positions to interpose the optical axis AX symmetrically in the Y direction clockwise by several degrees, are irradiated with the exposure light IL. In this case, when the information about the illumination condition and the like is supplied from the main control system 24 to the AOM driving system 27, the AOM driving system 27 makes the irradiation units 48A, 48B alternately supply the non-exposing lights LBA, LBB. Further, the AOM driving system 27 drives the AOM's 52A, 52B so that the irradiation areas 53A, 53B of the non-exposing lights LBA, LBB emitted from the two irradiation units 48A, 48B are rotated clockwise by several degrees with respect to center positions B2A, B2B of the variable ranges as shown in FIG. 5B. That is, it is also possible to recognize that the AOM's 52A, 52B rotationally move the irradiation areas 53A, 53B of the non-exposing lights LBA, LBB or the light-exit directions of the non-exposing lights LBA, LBB from the AOM's 52A, 52B in the circumferential direction about the center of the optical axis AX. Accordingly, the lens 32 has the temperature distribution which is approximately rotationally symmetric; and thus the non-rotationally symmetric aberration, which includes the center astigmatism, etc. is corrected.

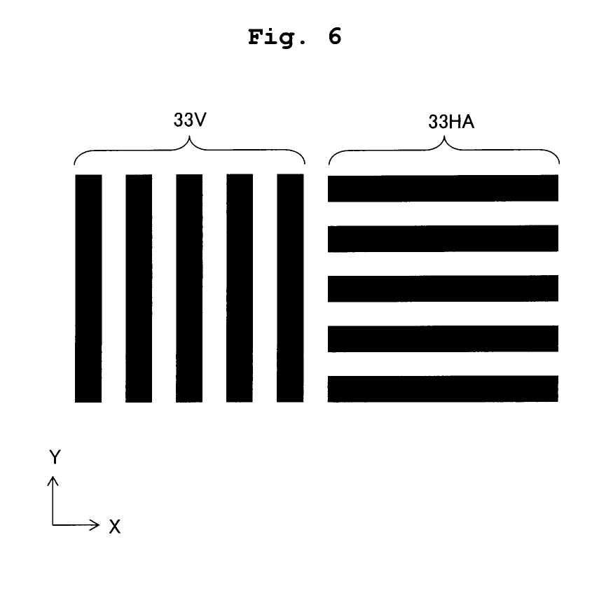

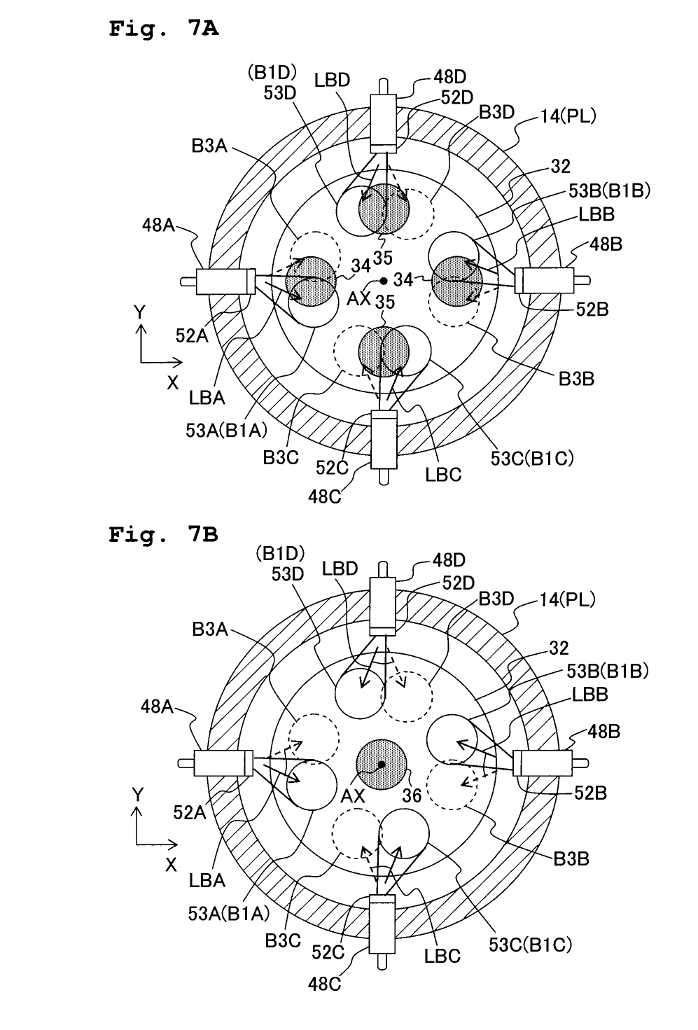

On the other hand, in a case that the L & S pattern 33V in the X direction and the L & S pattern 33HA in the Y direction shown in FIG. 6 are principally formed on the reticle 11 in parallel, for example, the quadruple illumination, which is provided by combining the dipole illumination in the X direction and the dipole illumination in the Y direction, is used. As shown in FIG. 7A, as for the lens 32 disposed in the vicinity of the pupil plane PP of the projection optical system PL, the four circular areas 34, 35, which symmetrically interpose the optical axis AX in the X direction and the Y direction, are irradiated with the exposure light IL. In this case, the information about the illumination condition and the like is supplied from the main control system 24 to the AOM driving system 27; and the AOM driving system 27 emits the non-exposing light LB from the light source system 41. After that, the AOM driving system 27 drives the AOM 46, which is included in the time-sharing unit 44 shown in FIG. 2C, so that the incident non-exposing light LB is periodically supplied as the non-exposing lights LBA, LBB, LBC, LBD to the optical fibers 49A, 49B, 49C, 49D at approximately identical time intervals. Further, the AOM driving system 27 drives the AOM's 52A to 52D shown in FIG. 7A, so that the irradiation areas 53A, 53B, 53C, 53D of the non-exposing lights LBA to LBD emitted from the irradiation units 48A, 48B, 48C, 48D are alternately moved to two positions B1A, B3A, two positions B1B, B3B, two positions B1C, B3C, and two positions B1D, B3D, respectively, each of the two positions symmetrically interposing the area 34 or 35 on the lens 32 in the circumferential direction. That is, it is also possible to recognize that the AOM's 52A to 52D rotationally move the irradiation areas 53A, 53B, 53C, 53D of the non-exposing lights LBA to LBD in the circumferential direction about the center of the optical axis AX. Also in this case, actually, the irradiation areas 53A to 53D are successively irradiated with the non-exposing lights LBA to LBD periodically. Specifically, it is also allowable that for example, the position B1A, the position B1B, the position B1C, and the position B1D are irradiated with the non-exposing light in this order, and then the position B3A, the position B3B, the position B3C, and the position B3D are irradiated with the non-exposing light in this order. Alternatively, the positions B1A, B3A, the positions B1B, B3B, the positions B1C, B3C, and the positions B1D, B3D may be irradiated with the non-exposing light in this order. The order or sequence of the irradiation may be arbitrary provided that the positions are uniformly or equivalently irradiated with the non-exposing light. In any case, the AOM driving system 27 controls the timings for driving the AOM 46 and the AOM's 52A to 52D in synchronization, so that the irradiation is executed for all of the emitting or light-exit directions and the irradiation positions of the non-exposing lights capable of being changed by the AOM's 52A to 52D. With this, it is possible to control the temperature distribution of the lens 32 by irradiating or radiating the non-exposing lights onto the desired positions in the wide area of the lens 32 by a small number of light source or sources and a small number of irradiation system or systems.

Accordingly, even when these four areas 34, 35 are irradiated with the exposure light IL, the lens 32 has the temperature distribution which is close to the rotational symmetry, i.e., the temperature distribution is uniform in the circumferential direction about the center of the optical axis of the lens. Therefore, the non-rotationally symmetric aberration, which includes the center astigmatism, etc. is corrected.

Further, when the higher-order rotationally symmetric aberration, which includes the higher-order spherical aberration, etc. is caused, for example, in a case that the exposure is performed under the illumination condition in which the light amount distribution is greatly fluctuated or varied in the radial direction on the pupil plane of the projection optical system PL, then the higher-order rotationally symmetric aberration can be decreased by irradiating the non-exposing light as in the embodiment of the present invention as well. As an example, in a case that the small σ illumination is performed, then as shown in FIG. 7B, the exposure light IL is made to pass through a small circular area 36 including the optical axis AX and an area disposed in the vicinity of the circular area 36 on the lens 32 disposed in the vicinity of the pupil plane PP of the projection optical system PL, and the light amount distribution is greatly fluctuated in the radial direction. In this case, the information about the illumination condition and the like is supplied from the main control system 24 to the AOM driving system 27; and the AOM driving system 27 makes the light source system 41 emit the non-exposing light LB therefrom. After that, the AOM driving system 27 drives AOM 46, which is included in the time-sharing unit 44 shown in FIG. 2C, so that the incident non-exposing light LB is periodically supplied as the non-exposing lights LBA, LBB, LBC, LBD to the optical fibers 49A, 49B, 49C, 49D at approximately identical time intervals. Further, the AOM driving system 27 drives the AOM's 52A to 52D shown in FIG. 7B, so that the irradiation areas 53A, 53B, 53C, 53D of the non-exposing lights LBA to LBD emitted from the irradiation units 48A, 48B, 48C, 48D are periodically moved between the positions B1A, B3A, the positions B1B, B3B, the positions B1C, B3C, and the positions B1D, B3D in the areas which surround the areas 36 of the lens 32 respectively.

Accordingly, the light amount distribution in the radial direction of the lens 32 is approximately uniform, and thus the higher-order aberration, which includes the higher-order spherical aberration, etc. is corrected.

The timings, which are represented by the following cases (a) to (g), are assumed as the irradiation timings of the non-exposing light to be emitted by the non-exposing light irradiation apparatus 40 described above. The use of any one of the timings may be judged in every production process.

(a) The non-exposing light is radiated depending on the fluctuation amount of the aberration component. (b) The non-exposing light is radiated in synchronization with the radiation of the exposure light. (c) The non-exposing light is radiated during the stepping of the wafer stage 20 shown in FIG. 1. (d) The non-exposing light is radiated during the exchange of the wafer. (e) The non-exposing light is radiated under the condition that the fluctuation amount of the aberration component is not less than a threshold value. As for the fluctuation amount of the aberration component, the threshold value is compared with an actually measured value or a calculated value. (f) The non-exposing light is radiated when the illumination condition is switched. (g) The non-exposing light is always radiated. The fluctuation amount of the aberration component can be determined in accordance with the method described above.

The embodiment of the present invention provides the following functions and effects.
(1) The apparatus, which includes the non-exposing light irradiation apparatus 40 and the lens 32 in the projection optical system PL of this embodiment, is the apparatus having the lens 32 to be irradiated with the exposure light IL (first illumination light), the apparatus including the light source system 41 which emits the non-exposing lights LBA to LBD (second illumination lights) having the wavelength region different from that of the exposure light IL, the irradiation units 48A to 48D which irradiate the irradiation areas 53A to 53D on the surface of the lens 32 with the non-exposing lights LBA to LBD emitted by the light source system 41, the AOM's (acousto-optic modulation elements) 52A to 52D (acousto-optic systems) which are arranged between the light source system 41 and the surface of the lens 32, and the AOM driving system 27 which drives the AOM's 52A to 52D in order to change the positions of the irradiation areas 53A to 53D of the non-exposing lights LBA to LBD.

According to this apparatus, the lens 32 is irradiated with the non-exposing lights LBA to LBD for correcting the imaging characteristic in the projection optical system PL. The irradiation positions of the non-exposing lights LBA to LBD with respect to the lens 32 can be changed with the simple structure or construction, merely by switching the frequency of the ultrasonic wave in the AOM's 52A to 52D arranged between the light source system 41 and the lens 32 to thereby change the diffraction angles (in the plane perpendicular to the optical axis of the lens 32). Further, according to this apparatus, the irradiation positions of the non-exposing lights LBA to LBD with respect to the lens 32 can be changed without generating any vibration. Therefore, even when the light amount distribution of the exposure light IL is non-rotationally symmetric (nonuniform) in various ways, the light amount distribution or the thermal deformation of the lens 32 can be approximate to the rotational symmetry by changing the irradiation positions of the non-exposing lights LBA to LBD depending thereon.
(2) The irradiation units 48A to 48D have the optical fibers 49A to 49D which transmit the non-exposing lights LBA to LBD emitted by the light source system 41 to the surface of the lens 32. Each of the AOM's 52A to 52D is arranged between the surface of the lens 32 and one of the optical fibers 49A to 49D. In the construction in which the AOM's 52A to 52D are arranged on the optical paths of the non-exposing lights LBA to LBD as described above, the construction can be simplified, and the irradiation mechanism can be easily assembled and adjusted, as compared with any construction in which the optical paths of the non-exposing lights LBA to LBD are deflected, for example, by any mirror.
(3) The plurality of (four) sets of irradiation units 48A to 48D and the plurality of (four) sets of AOM's 52A to 52D are provided corresponding to the plurality of irradiation areas 53A to 53D of the surface of the lens 32. Therefore, even in a case that the deflection amounts of the non-exposing lights LBA to LBD, which are brought about by the individual AOM's 52A to 52D, are small, any arbitrary area on the substantially entire surface of the outer circumferential portion of the lens 32 can be irradiated with the non-exposing lights.

The number of the irradiation units 48A to 48D as well as the number of the AOM's 52A to 52D is arbitrary. Further, for example, in a case that the deflection amount of the light flux, which is brought about by the AOM 52A, can be increased, then the irradiation unit 48A and the AOM 52A may be arranged at only one portion around the lens 32, and any necessary area of the surface of the lens 32 may be irradiated in a time-sharing manner with the non-exposing light LBA emitted from the irradiation unit 48A via the AOM 52A.
(4) The non-exposing light irradiation apparatus 40 is provided with the time-sharing unit 44 (switching section) which has the AOM 46 for switching, in the time-sharing manner, the non-exposing light LB emitted from the light source system 41 and supplying the non-exposing light LB to the irradiation units 48A to 48D. Therefore, the non-exposing lights LBA to LBD can be successively emitted from the plurality of irradiation units 48A to 48D disposed around the lens 32 by using one light source system 41.
(5) The lens 32 constitutes a part of the projection optical system PL which forms the image of the pattern of the reticle 11 on the wafer 18. Therefore, in a case that the light amount distribution of the exposure light IL is non-rotationally symmetric (nonuniform) on the pupil plane, it is possible to reduce the non-rotationally symmetric imaging characteristic of the projection optical system PL.
(6) The exposure apparatus of the embodiment of the present invention is the exposure apparatus which illuminates the pattern of the reticle 11 with the exposure light IL and which exposes the wafer 18 with the exposure light IL via the pattern and the projection optical system PL, wherein the exposure apparatus is provided with the apparatus which includes the non-exposing light irradiation apparatus 40 described above as the projection optical system PL.
Therefore, it is possible, for example, to correct the non-rotationally symmetric imaging characteristic or to reduce the higher-order aberration of the projection optical system PL. Therefore, the pattern of the reticle 11 can be transferred onto the wafer 18 highly accurately.
(7) In a case that the illumination condition for the reticle 11 is, for example, the dipole illumination which is non-rotationally symmetric (nonuniform), the positions of the irradiation areas 53A to 53D of the non-exposing lights LBA to LBD with respect to the lens 32 included in the projection optical system PL are changed depending on the illumination condition. Therefore, even in a case that the non-rotationally symmetric illumination condition is used, the pattern of the reticle 11 can be transferred onto the wafer 18 highly accurately.
(8) The exposure method of the embodiment of the present invention includes making the non-exposing lights LBA to LBD (second illumination lights), having the wavelength region different from that of the exposure light IL, come into the acousto-optic modulation elements 52A to 52D and irradiating the lens 32 (optical element) included in the projection optical system with the second illumination lights exiting from the acousto-optic elements; driving the acousto-optic elements to change the irradiation areas of the second illumination lights to be irradiated onto the optical element; and illuminating the pattern of the reticle with the first illumination light to expose the object with the first illumination light via the pattern and the projection optical system. According to this method, the irradiation positions or the irradiation directions of the non-exposing lights LBA to LBD with respect to the lens 32 can be changed with the simple construction merely by changing the diffraction angles by switching the frequency of the ultrasonic wave in the acousto-optic modulation elements 52A to 52D. Further, according to this method, the irradiation positions or the irradiation directions of the non-exposing lights LBA to LBD with respect to the lens 32 can be changed without generating any vibration. Therefore, even when the light amount distribution of the exposure light IL is non-rotationally symmetric (nonuniform) in various ways, the light amount distribution or the thermal deformation of the lens 32 can be approximate to the rotational symmetry (uniformity) by changing the irradiation positions of the non-exposing lights LBA to LBD depending thereon.

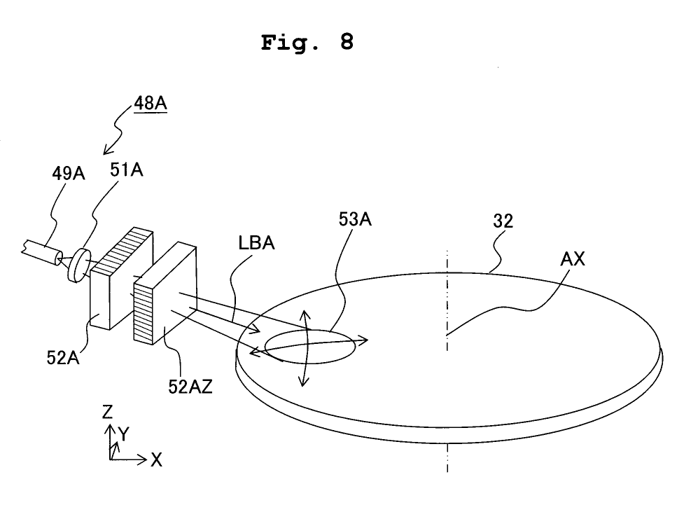

Next, the embodiment described above can be modified as follows.
(1) In FIG. 2A, each one of the AOM's 52A to 52D is provided for each of the irradiation units 48A to 48D. Therefore, the irradiation areas 53A to 53D can be changed one-dimensionally. On the other hand, as shown in FIG. 8, it is also allowable to arrange, between the irradiation unit 48A and the lens 32, a first AOM 52A which deflect the non-exposing light LBA in the Y direction (direction perpendicular to the optical axis of the lens 32) and a second AOM 52AZ which deflects the non-exposing light LBA in the Z direction (optical axis direction of the lens 32). According to this modification, the position of the irradiation area 53A of the non-exposing light LBA can be changed two-dimensionally in the X direction and the Y direction on the lens 32.
(2) In the embodiment described above, the non-exposing light LB from the light source system 41 is divided into those for the plurality of irradiation units 48A to 48D by the time-sharing unit 44 including the AOM 46. However, the non-exposing light LB from the light source system 41 may be supplied to the irradiation units 48A to 48D in a time-sharing manner by, for example, an optical system provided by combining a plurality of galvano-mirrors. Further, for example, in a case that the light source of the non-exposing light is a semiconductor laser, the light source may be provided for each of the irradiation units 48A to 48D.
(3) When the lens which is to be irradiated with the non-exposing light is a lens disposed in the vicinity of the pupil plane of the projection optical system PL conjugate with the pupil plane of the illumination optical system ILS, as the lens 32 of the embodiment described above, the effect to correct the center astigmatism, etc. is enhanced.

However, the non-exposing light may be radiated onto a plurality of lenses disposed in the vicinity of the pupil plane of the projection optical system PL. Further, for example, in a case of suppressing the fluctuation of the imaging characteristic which is caused by any rectangular illumination area, the non-exposing light may be radiated onto one optical element or a plurality of optical elements disposed on the object plane side and/or the image plane side of the projection optical system PL.

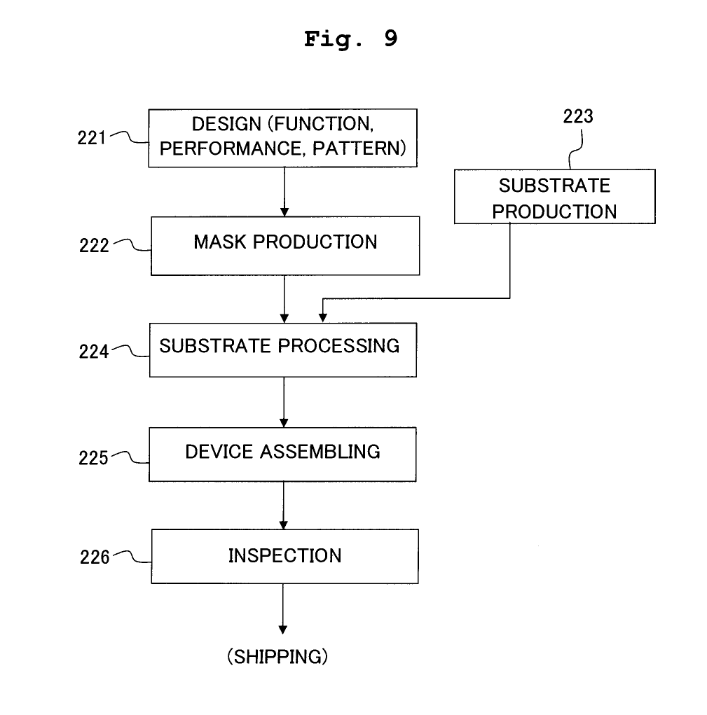

In a case that an electronic device (or a microdevice) such as a semiconductor device or the like is produced by using the exposure apparatus (exposure method) of the embodiment described above, as shown in FIG. 9, the electronic device is produced by performing a step 221 of designing the function and the performance of the electronic device; a step 222 of manufacturing a reticle (mask) based on the designing step; a step 223 of producing a substrate (wafer) as a base material for the device and coating the substrate (wafer) with a resist; a substrate-processing step 224 including a step of exposing the substrate (photosensitive substrate) with the pattern of the reticle by the exposure apparatus (exposure method) of the embodiment described above, a step of developing the exposed substrate, a step of heating (curing) and etching the developed substrate, etc.; a step 225 of assembling the device (including processing processes such as a dicing step, a bonding step, and a packaging step); an inspection step 226; and the like.

In other words, the method for producing the device includes transferring the image of the pattern of the reticle to the substrate (wafer) by using the exposure apparatus (exposure method) of the embodiment described above, and processing the substrate subjected to the transfer in accordance with the image of the pattern (Step 224). In this process, according to the embodiment described above, for example, various non-rotationally symmetric imaging characteristics of the projection optical system PL of the exposure apparatus can be corrected highly accurately. Therefore, it is possible to produce various electronic devices highly accurately.

The present invention is applicable not only to the exposure apparatus of the scanning exposure type but also to a case in which the exposure is performed by an exposure apparatus of the full field exposure type such as a stepper or the like, in the same manner as described above. The present invention is also applicable to a case that the imaging characteristic is corrected in an exposure apparatus which uses a projection optical system including a catoptric system or a dioptric system and an exposure apparatus of the liquid immersion type wherein a liquid through which the exposure light is transmitted is supplied to a space between a projection optical system and an object (wafer or the like) as the exposure objective as disclosed, for example, in United States Patent Application Publication Nos. 2005/0248856 and 2007/242247 and European Patent Application Publication No. 1420298. In this case, the present invention is applicable not only to an exposure apparatus of the local liquid immersion type in which the liquid is intervened in only a local space between the projection optical system and the object but also to an exposure apparatus of such a liquid immersion exposure type that the entire object is immersed in the liquid. The present invention is also applicable to an exposure apparatus of the liquid immersion type in which a liquid immersion area between a projection optical system and a substrate is held by an air curtain provided therearound. The present invention is also applicable to an exposure apparatus or exposure method of the multi-stage type provided with a plurality of stages as disclosed, for example, in U.S. Pat. Nos. 6,590,634, 5,969,441, and 6,208,407. Further, the present invention is also applicable to the use of an exposure apparatus and exposure method provided with a measuring stage having a measuring member (for example, a reference mark and/or a sensor) as disclosed, for example, in International Publication No. 1999/23692 and U.S. Pat. No. 6,897,963.

As for the way of use of the exposure apparatus of the present invention, the present invention is not limited to the exposure apparatus for producing the semiconductor device. The present invention is also widely applicable, for example, to an exposure apparatus for producing a display apparatus including, for example, a liquid crystal display element formed on a rectangular or square glass plate and a plasma display, and an exposure apparatus for producing various devices including, for example, an image pickup element (CCD, etc.), a micromachine, a thin film magnetic head, and a DNA chip. That is, the object, on which the pattern is to be formed, is not limited to the wafer. The object may be, for example, glass plates, ceramic substrates, film members, and mask blanks; and the shape thereof is not limited to the circular shape, which may be, for example, any rectangular shape as well. Further, the present invention is also applicable to an exposure step (exposure apparatus) for producing masks (photomasks, reticles or the like), which are formed with mask patterns of various devices, by using the photolithography step as described above.

The projection exposure apparatus of the embodiment described above can be produced by incorporating the illumination optical system and the projection optical system, which are constructed of a plurality of lenses, into the body of the main exposure apparatus; performing the optical adjustment; attaching the reticle stage and the wafer stage, which are constructed of a large number of mechanical parts, to the body of the exposure apparatus to connect wirings and pipings thereto; and performing the overall adjustment (the electric adjustment, the confirmation of the operation, etc.). It is desirable that the exposure apparatus is produced in a clean room in which the temperature, the cleanness, etc. are managed.

The disclosures of the published patent documents, the respective international patent publication pamphlets, and the specifications of the US patent documents and the US patent application publications cited in this patent application are incorporated herein by reference.

It is a matter of course that the present invention is not limited to the embodiments described above, and may be embodied in other various forms without deviating from the gist or essential characteristics of the present invention.

According to the present invention, the irradiation position of the second illumination light with respect to the optical element can be changed with the simple construction by using the acousto-optic system arranged between the light source and the surface of the optical element. Further, by using the acousto-optic system, the irradiation position of the second illumination light with respect to the optical element can be changed without generating any vibration. By using the present invention, the exposure can be performed with excellent imaging characteristic under various illumination conditions depending on various patterns as well. Therefore, the present invention can remarkably contribute to the international development of the precision mechanical equipment industry including the semiconductor industry.

What is claimed is:

1. An optical apparatus having an optical element which is irradiated with a first illumination light, the optical apparatus comprising:
a light source which emits a second illumination light having a wavelength region different from that of the first illumination light;
an irradiation mechanism which irradiates at least a part of a surface of the optical element with the second illumination light emitted by the light source;
an acousto-optic system which is arranged between the light source and the surface of the optical element; and
a controller which drives the acousto-optic system to change an irradiation position of the second illumination light with respect to the surface of the optical element.

2. The optical apparatus according to claim 1, wherein the acousto-optic system has first and second acousto-optic elements of which directions of deflection with respect to an incident light flux are intersected and which are arranged in series between the light source and the surface of the optical element; and
the controller drives the first and second acousto-optic elements to two-dimensionally change the irradiation position of the second illumination light with respect to the surface of the optical element.

3. The optical apparatus according to claim 1, wherein the irradiation mechanism has an optical fiber which transmits the second illumination light emitted by the light source to the surface of the optical element; and
the acousto-optic system is arranged between the optical fiber and the surface of the optical element.

4. The optical apparatus according to claim 1, wherein the second illumination light is irradiated onto the surface of the optical element at a plurality of irradiation positions; and
the irradiation mechanism and the acousto-optic system are provided with a plurality of irradiation mechanisms and a plurality of acousto-optic elements which are provided corresponding to the plurality of irradiation positions respectively.

5. The optical apparatus according to claim 4, further comprising a switching section having an additional acousto-optic element which switches the second illumination light emitted from the light source in a time-sharing manner and which supplies the second illumination light to the plurality of irradiation mechanisms.

6. The optical apparatus according to claim 1, wherein the optical element constitutes a part of a projection optical system which forms an image of a pattern disposed on a first surface on a second surface.

7. The optical apparatus according to claim 6, wherein the controller changes the irradiation position of the second illumination light with respect to the surface of the optical element via the irradiation mechanism and the acousto-optic system to control a non-rotationally symmetric imaging characteristic of the projection optical system.

8. An exposure apparatus which illuminates a pattern with an illumination light and which exposes an object with the illumination light via the pattern and a projection optical system, wherein the projection optical system comprises the optical apparatus as defined in claim 6.

9. The exposure apparatus according to claim 8, wherein the controller changes the irradiation position of the second illumination light with respect to the surface of the optical element depending on an illumination condition for illuminating the pattern.

10. A method for producing a device, comprising:
forming a pattern of a photosensitive layer on a substrate by using the exposure apparatus as defined in claim 9; and
processing the substrate formed with the pattern of the photosensitive layer.

11. An exposure method for illuminating a pattern with a first illumination light and exposing an object with the first illumination light via the pattern and a projection optical system, the exposure method comprising:
irradiating, with a second illumination light having a wavelength different from that of the first illumination light, an optical element included in the projection optical system, via an acousto-optic element;
driving the acousto-optic element to change an irradiation area of the second illumination light to be irradiated onto the optical element; and
illuminating the pattern with the first illumination light to expose the object with the first illumination light via the pattern and the projection optical system.

12. The exposure method according to claim 11, wherein the pattern is illuminated with the first illumination light via an aperture diaphragm, and the irradiation area of the second illumination light is changed depending on an illumination condition set by the aperture diaphragm.

13. The exposure method according to claim 11, wherein the irradiation area of the second illumination light is changed in a circumferential direction about a center of an optical axis of the optical element.

14. The exposure method according to claim 11, wherein the acousto-optic element is provided as a plurality of acousto-optic elements which surround the optical element, and a light-exit direction of the second illumination light from each of the elements is changeable.

15. The exposure method according to claim 14, wherein the second illumination light is made to exit while changing the light-exit direction of the second illumination light from each of the elements.

16. The exposure method according to claim 14, wherein the second illumination light is made to exit alternately from the plurality of elements.

17. The exposure method according to claim 11, wherein the irradiation area of the second illumination light on the optical element is different from an area which is irradiated with the first illumination light.
